(19) United States
(12) Patent Application Publication
(10) Pub. No.: US 2004/0264917 A1
(43) Pub. Date: Dec. 30, 2004

(54) Audio waveform cueing for enhanced visualizations during audio playback

(75) Inventors: Jeff Braun, Orinda, CA (US); Zane Vella, San Francisco, CA (US); Ole Luljens, San Francisco, CA (US)

Correspondence Address: CARPENTER & KULAS, LLP, 1900 EMBARCADERO ROAD, SUITE 109, PALO ALTO, CA, 94303, US

(73) Assignee: M/X Entertainment, Inc., San Francisco, CA

(21) Appl. No.: 10/603,357

(22) Filed: Jun. 25, 2003

(51) Int. Cl. H04N 5/781

(52) U.S. Cl. 386/46; 386/125

(57) ABSTRACT

Cues, or indicators, are associated with an audio waveform. The cues can be placed or arranged automatically, or manually by a human operator. During playback, the cues are detected by a playback device and can be used by a visualization to correlate images, animation, colors, or other characteristics of the waveform to a visual presentation. Different cues correspond to different basic song characteristics such as percussion or beat. Instrument cues are used for noticeable instrument phrases, notes, or effects. Instrument solo cues are used to indicate the start and end of instrument solos or passages that stand out. Vocal cues include a range of coarse, medium or fine vocal tracking to provide cues for, e.g., mere presence of vocals, to close tracking of words, melody and emotional delivery. A playback engine uses the cues to create a visualization.

### BACKGROUND OF THE INVENTION

This invention relates in general to audio playback and more specifically to audio playback where visual imagery is synchronized to the playback.

A “visualization” of an audio playback is a visible presentation that corresponds with the audio playback. Typically, an audio presentation, such as a song, is used to trigger abstract moving images and color that are synchronized to the rhythm, melody, vocals, or other characteristics of the audio. Visualizations can take many forms. Several digital audio players, such as Media Player™ from Microsoft, Inc.; RealOne™ from Real, Inc., Winamp from Nullsoft™, etc., provide many different types of visualizations.

Visualizations work by separating, or “filtering,” the audio playback into different bands, or frequency ranges, and then analyzing the energy in each band. In such a band-filtering approach, for example, a four-band visualization might use a first band to identify low frequencies, second and third bands for low-middle and high-middle frequencies, respectively, and a fourth band for high frequencies. A visualization engine is a software process, hardware processing or a combination of both, executing on a user's playback device. The visualization engine analyzes each band to determine characteristics of a band such as power, activity, sub-frequencies, amplitude, etc. The analysis can also identify time-dependent regularities such as beats, phrases, and can sometimes identify separate instrument and vocal activity.

One problem with the traditional visualization approach is that, even by using many bands and intensive analysis, the visualizations are only loosely and superficially related to the music. Most visualizations do not show a high correspondence of synchronism with a song. Usually a user, or viewer, can only notice very basic features of a song in a visualization, such as low-frequency beat, or overall volume of the song. At times, a viewer is hard-pressed to detect any correlation, at all, between the audio playback and visualization imagery.

The prior art approach to visualizations also requires complex programming and can use a lot of a computer's, or other playback device's, resources, such as central processing unit (CPU) cycles, memory, bus bandwidth, etc. This is a drawback in modern applications where the audio playback and visualization may be running in a shared environment, such as in an operating system on a personal computer, or on a digital versatile disk (DVD) player, where other applications and processes are competing for the same resources.

Other prior art approaches include the use of software authoring tools to create visual “performances” that can be played back while an audio playback is also occurring. Examples of such software include “Arkaos,” by M-Audio and “Jitter” by Cycling 74. These approaches allow creation of a visualization by using keyboard and mouse actions to trigger and record an author's inputs. Since the visualization is pre-recorded, an author is usually limited to the specific types of effects, or plug-ins, available at the time of creating the performance. Also, many of the effects are based on band-filtering and can suffer from loose synchronism and very abstract correspondence with the audio, as described, above.

### BRIEF SUMMARY OF THE INVENTION

The present invention uses cues, or indicators, associated with an audio waveform. The cues can be placed or arranged automatically, or manually by a human operator. During playback, the cues are easily detected by a process or device to display correlating images and animation in a “visualization,” or visual playback of a song. The visualization can include artistic animation of shapes, colors, or other visual characteristics. The cues can be used apart from, or together with, prior art approaches, to provide visualizations.

In one embodiment, different cues correspond to different basic song characteristics. Kick drum, snare and bass guitar cues are used to indicate the basic rhythm of a song. Secondary percussion cues are used for, e.g., cymbal hits, tom-tom hits and other percussion instruments such as a tambourine, shaker, congas, etc. Instrument cues are used for noticeable instrument phrases, notes, or effects. Instrument solo cues are used to indicate the start and end of instrument solos or passages that stand out. Vocal cues include a range of coarse, medium or fine vocal tracking to provide cues for, e.g., mere presence of vocals, to close tracking of words, melody and emotional delivery. Other types of cues are described.

A playback engine uses the cues to create a visualization. The playback engine can ignore cues and can also create new data based on the cue data by interpolating between, or among, cues or by using other rules, defaults or processing to derive data for visualizations.

One embodiment of the invention provides a method for playing back an audio presentation with an accompanying visual presentation, the method comprising detecting a cue indicating a characteristic of music of the audio presentation; and using the cue to modify a visual presentation in synchronization with the audio presentation.

Another embodiment provides a method for authoring a visualization, the method using a display screen coupled to a user input device and to a processor, the method comprising the following steps executed by the processor displaying a representation of an audio waveform on the display screen; accepting signals from the user input device to create a cue at a selected point in the representation of the audio waveform; displaying a visual indicator corresponding to the cue adjacent to the representation of the audio waveform near the selected point; and storing an indication of the cue at the selected point.

### DETAILED DESCRIPTION OF THE INVENTION

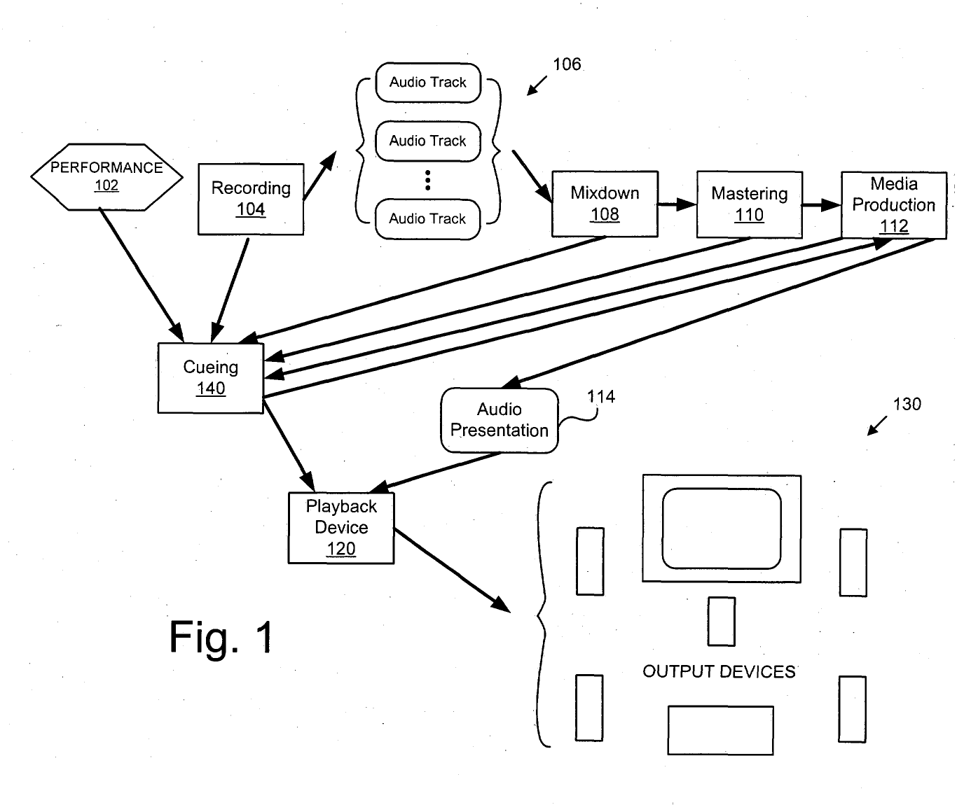

FIG. 1 illustrates basic steps in the creation and playback of an audio presentation with cues for visualization playback.

In FIG. 1, a production process for creation of an audio presentation begins with a musical performance 102. Recording 104 of the performance results in one or more audio tracks 106. The audio tracks go through mixdown 108, mastering 110 and production 112 processing to result in an audio presentation in a format suitable for consumer playback. Such a format can be, e.g., mp3, .wav, .aiff, MPEG-4, Super-DVD or any other stored, streamed, or other format. The audio presentation is delivered to playback device 120 that typically resides in a remote location such as in a consumer's home, or somewhere in proximity to a user, listener, or viewer. Output devices, such as stereo, surround sound or other speaker systems; and display devices such as a computer screen or monitor, or smaller display panel on a portable device are shown at 130. Note that any type of suitable playback device and output devices can be used.

Cues can be obtained from any of several points in the production process. For example, in FIG. 1, the step of creating cues is shown as cueing 140. Input to the cueing step can occur at one or more of performance 102, recording 104, mixdown 108, mastering 110 and production 112 steps as shown by arrows leading to cueing 140. Cueing input data can be obtained from other sources not shown in FIG. 1. Cue data can be combined with an audio presentation by providing a cue file to the production step so that (as described below) cue data is included as embedded or associated data with the audio presentation. Alternatively, the cue data can be provided separate from the audio presentation as, e.g., a separate file, object, or other data obtained from the Internet directly to the playback device to be used in association with audio playback.

FIG. 1 shows only a few basic possibilities of generating cue data, associating cue data with audio data, and of transferring cue data among different steps and hardware in a typical production and playback process. Other variations are possible.

Cues can be generated automatically or manually. A preferred embodiment of the invention uses manual generation of cues with automated assistance in post-production, as where a human operator works with a recorded audio waveform on a digital audio workstation (DAW). Many of the manual steps described herein can be automated, at least to some degree. An advantage to automation is that cues can be generated more quickly and uniformly. However, manual cueing is preferable in many instances because it allows an artist/operator to create more effective, interesting, or artistic cues that can result in a more dramatic visualization. A preferred embodiment uses automated enhancement to generate certain types of cues, as described, below.

Different possibilities for cues exist depending on where in the production process cues are generated. For example, if cues are generated, or captured, at performance 102 then aspects of the actual live performance can be used to generate cues. Different stage lighting effects can be monitored and turned into cues. Elaborate “live” lighting systems are typically computer controlled under a human operator's supervision to generate many different lighting effects including color, movement, blinking, shape generation, animations, etc. The computer lighting systems can output lighting signal data that can be turned directly into cues that are synchronized to the audio presentation. For example, when a spotlight is turned on a SPOTLIGHT-ON cue is generated. Similarly, a SPOTLIGHT-OFF cue is generated when the light is turned off. If a fine (as opposed to coarse) degree of cueing is employed then the spotlight motion can be tracked with spotlight coordinate cues as, e.g., SPOTLIGHT(x, y) at different time intervals in the audio presentation. SPOTLIGHTCOLOR cues also allow color indication such as SPOTLIGHTCOLOR(blue). Note that many such cues can be captured for any type of lighting effects that occur during an actual live performance. If such data is not available from an automated lighting system then the data can be entered by a human operator with a suitable input device such as a keyboard, mouse, motion capture, etc.

Movements of musicians, dancers, and others can also be recorded, or captured, as cues. Motion capture techniques can be used to associate cues with, e.g., a drummer's hand, arm and leg movements, singer's mouth, head or overall body position movements, etc. Signals from actual instruments can also be captured and automatically transformed into cues. For example, the Musical Instrument Digital Interface (MIDI) commands from a keyboard represent the exact way that a musician is playing a keyboard. The MIDI commands can be electronically translated into cues for visualization playback.

A manual approach to generating cues at a live performance includes using one or more operators to enter signals depending on different operator assignments. For example, one operator can monitor the beat and can tap onto an input device in time with the basic beat. Another operator can enter signal cues whenever a singer is singing. Other operators can be assigned to different musicians, dancers, or other entertainers; or to different aspects or characteristics of the music.

Additional possibilities and efficiencies can be realized when the recording does not occur as a live performance, but, instead, takes place in a studio environment where musicians record tracks of different instruments one-at-a-time. A studio environment allows more time for setup of elaborate signal translation, motion capture, instrument recording and other techniques that can produce effective cues. For example, a drum set is usually recorded with separate microphones for different drums. This makes it easy to automatically create cues for each drum by, e.g., placing a sound or vibration trigger on or near each drum, or by using the signal from each drum's microphone to generate cues. It also allows for multiple “takes” of musical passages and cue capture attempts.

Analysis of components of the live performance can be processed at the time the live performance is being performed and/or recorded. For example, the filter analysis that is performed by the prior art visualizations to detect the strength, or power, of different frequency bands can be performed in real time during the live performance. The results of the filter analysis can be associated with different points in the waveform as “filter cues.” One type of filter cue includes a value to indicate a frequency band's strength over an interval of time. Another type of filter cue can be a flag that indicates that a signal of a selected frequency component, or band, and of sufficient strength (e.g., above a predetermined threshold value) is present in the waveform at approximately the time, or sample, associated with the occurrence of the cue. These filter cues are associated with the audio signals so that a visualization engine does not need to later compute the filter responses.

After recording 104 there are additional possibilities for generating cues. Cue generation can now proceed in non-real time on the pre-recorded audio signals. This allows, for example, an automated process to determine song characteristics such as the basic beat, filter analysis, etc. Typical recording approaches, both live and studio, also use multiple microphones or sound sources for a single performance. More elaborate cue generation is possible with the availability of multiple isolated tracks, the ability to process tracks in non-real time, and the opportunity to make as many tries as necessary to generate desired cues. Also, cue lists can be edited or modified after their initial entry so that mistakes, or unwanted cues and cue placement, can be corrected.

Mixdown 108 and mastering 110 steps provide additional opportunites for generating or placing cues. During mixdown, a lot of audio manipulation occurs. Much of it is done with mix automation—signals that can be captured and turned into cues similarly to those describe above for motion capture and lighting effects. For example, an audio engineer or producer can select volume changes for each audio track. The audio tracks can also be “panned” among different speakers, e.g., in a stereo or surround-sound application. These mixing operations are usually recorded electronically so they can be automated during “mixdown.” Thus, the mixing board automation can be used to generate different cues.

An example of mixing board automation to generate a cue is the TRACK_N_PAN(0 . . . 255) cue where a track number N has a pan value that can vary from 0, or extreme left, to 255, or extreme right, in two-channel stereo mix. Any change in the TRACK_N_PAN value during a song's mix can result in a new cue associated with the audio playback. Other mixing board automation or operation can be similarly used. Track fader (i.e., volume) adjustments, bus volume, effects send and return levels, etc., can all be used to generate cues automatically (when electronic signals are available or can be generated) or manually as where an operator notes when such control changes occur and enters the cues (as discussed below) in association with the audio mixdown. Other embodiments using additional channels can include multiple parameters in the track panning cues. In general, any characteristic of a track, mix or other portion of an audio presentation can be represented with a parameter and that parameter included as part of a cue.

Other aspects of mixing lend themselves to advantageous generation of cues. Mixing uses many types of audio processing, effects and other processing from software processes or hardware devices (collectively referred to as “processors” or “processing”). For example, compressors, limiters, equalizers, signal conditioners, etc., are commonly used in mixing. Often several, or dozens, of such processors are used. These processors are increasingly automated in their parameters and controls and many of these devices are now operating in the digital domain. Any aspects of the operation of these processes or devices can be used as a parameter to generate a cue. For example, the existence of a signal at the input, or output, of a reverb unit can be used to generate a cue. The extent to which a compressor device is modifying (i.e., compressing) a signal can be used to generate another type of cue. Many types of such cues should be apparent.

Mastering 110 provides similar opportunities for cue generation. Although the modifications to the audio presentation at the mastering stage are somewhat less than those at the mixing stage, it may be advantageous to generate cues at the mastering step because the song's presentation is not going to be changing much, overall. Also, certain characteristics of the song, such as start time, ending time, song transitions (e.g., fade-ins), compression and volume are not fixed until the mastering stage:

Finally, cues can be generated at production stage 112. At the production stage all of the modifications to the audio presentation are complete. Manual and/or automated cue generation can proceed on the mixed and mastered song. Since cue files can be completely separate from any audio presentation file, it is possible to have “after market” cue files created by an entity other than the manufacturer or owner of an existing audio presentation file. For example, a cue file can be generated for an existing song, compact disc (CD) or other audio presentation. The file can be sold or transferred independently of any sale, license or use restrictions of the existing song. Typically a “sync” license (syncing music to visuals) would be required for commercial use. The cue file can be associated with the existing song file by using identification codes associated in a table in a central server. The cue file can also include identifying information about the song or CD, such as information used to maintain a CD database (CDDB).

A preferred embodiment uses features of a Digital Audio Workstation (DAW) or non-linear digital video editing system, or a combination of both systems to allow a human operator to generate waveform cues.

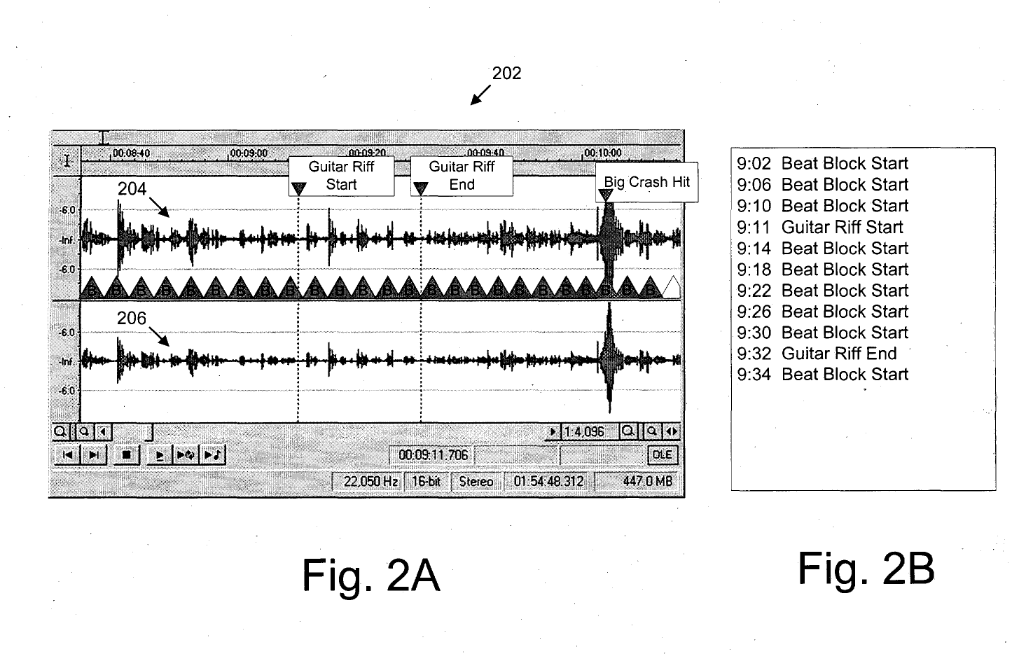

FIG. 2A illustrates a sample portion of an image of a workstation's user interface used to generate cues. In FIG. 2A, waveform window 202 includes first and second waveforms, 204 and 206, respectively, that can be, for example, left and right channels in a stereo audio file. The waveforms correspond to digital samples of audio over time. The time axis is the horizontal axis that extends to the right so that later samples and events occur to the right, and earlier samples and events are those to the left. Naturally, many other ways of displaying, or working with, audio waveforms are possible than those of specific embodiments discussed herein.

A time scale extends along the top of the waveform window. Cues are indicated with red triangles so that, for example, the cues GUITAR_RIFF_START and GUITAR_RIFF_END are at approximately 9:11 and 9:32, respectively. Similarly, BEAT_BLOCK cues are indicated along the midline of the window and occur at intervals of 4 seconds. In a preferred embodiment, cues are indicated in a waveform display by using a red triangle to point to the part of the waveform, timeline, or other reference with an optional text description or identification of the cue. Since the beat blocks occur frequently they are merely indicated with a “B,” while other events use more text to describe the events in more detail. In general, cues can be represented in association with waveforms by any sort of visual indicator or combination of indicators including shape, text, color, animation, etc. Some embodiments may also use sounds or other non-visual indicators to depict the existence and nature of cues in correspondence with an audio presentation. Cues other than those shown in FIG. 2A can be represented in a similar manner.

Another way to represent cues is with a cue list as shown in FIG. 2B.

In FIG. 2B, the cues are arranged in top-down order according to their occurrence in time. Beat blocks are shown spaced 4 seconds apart while other events are shown at their proper order of occurrence. Any effective manner of displaying, listing, ordering, organizing or manipulating cue indicators can be employed. Note that some workstation approaches do not use a waveform display. For example, MIDI note information is displayed as a series of discrete events where each MIDI note is merely a symbol such as a dot, block, etc., within a timeline or graph. Other approaches for audio editing and display are possible.

As discussed above, an operator can add cues in post-production (i.e., after the time of a recording) at any of the production process steps in FIG. 1. An operator can work with the visual waveform to play back the waveform repeatedly and manually place cues by using a keyboard and/or mouse input. So, for example, an operator can listen to the stereo tracks and hit the “R” key on a keyboard to place a GUITAR_RIFF_START cue at the point in the waveform that is playing at the time of the operator's keypress. Another press of the “R” key places the GUITAR_RIFF_END cue onto the display.

Other types of cues, such as the beat block cue, are more repetitive and time-consuming to manipulate and benefit from automation. Beat block cues typically indicate the start of a measure in a song. Each beat block corresponds to the number of beats in the measure (e.g., 4 beats per measure) and acts like a macro for a beat pattern for the measure. Since most songs use only a few, or a single, type of basic beat, once the beat pattern for a measure has been determined it can be re-used for every similar measure. For example, an operator can define a beat block as having four equally-spaced beats at a specified interval of time. Every time a beat block is placed, the first beat is associated with the beat block placement and subsequent beat blocks are assumed to follow the first beat according to the beat block definition.

Beat blocks can include any type of cues so that different rhythm instrumentation can be used by defining, e.g., a kick drum, snare drum, kick drum, snare drum, pattern. Bass lines, motion capture, or other types of cues can be included in beat blocks.

Cue indicators can benefit from many of the traditional types of operations used by digital audio workstations to handle events. For example, ordering, filtering, insertion, editing and other functions can be used on cue indicators. Cue lists can be saved and managed, copied, repeated, subjected to processing algorithms, etc.

Many types of cues are possible in addition to those already mentioned. One feature of the invention allows a range of cues from coarse to fine. A coarse placement of cues might only indicate when a singer is singing. A medium placement of cues might indicate the start of each word that is sung. A fine placement of cues might include identifying phonemes, or basic speech sounds, uttered by the singer so that a visualization could, for example, generate a close reproduction of mouth movements in an animation. Similarly, a beat pattern can include just a kick drum indication. Finer rhythms can include cues for up to all of the audible percussive instruments. Still other approaches can include cues for events that do not even exist in a song. For example, rhythm cues can be added for more enhanced visualizations.

Thus, far, the types of cues discussed are “physical” in nature because they are based on some detectable characteristic (e.g., filter bands, sound waveform, musician's movement, etc.) of the performance. Other types of cues do not have a physical basis but are “imaginary” in nature. Imaginary cues can have arbitrary or whimsical meanings and names. For example, a “mood” cue can indicate the when “suspenseful” or “happy” portions of a song occur. Such cues can use an intensity value (e.g., 1-10) to indicate the level of each type of mood. Still other imaginary cues can be set with knowledge of the type of visualization they will create. For example, a “rotation” cue can be used during a visualization to set the speed of rotation of one or more objects on the display screen. Although the operator who sets the rotation cue position, speed, and other attributes does not know how a visualization programmer will use the cue, there is some general meaning of the cue, i.e., rotation, that provides a common ground for using the cue effectively.

As discussed above in connection with FIG. 1, cues can be embedded or associated with audio presentation data. This approach is useful where the audio presentation data (e.g., a .wav file) and the cue data are advantageously treated as a single object.

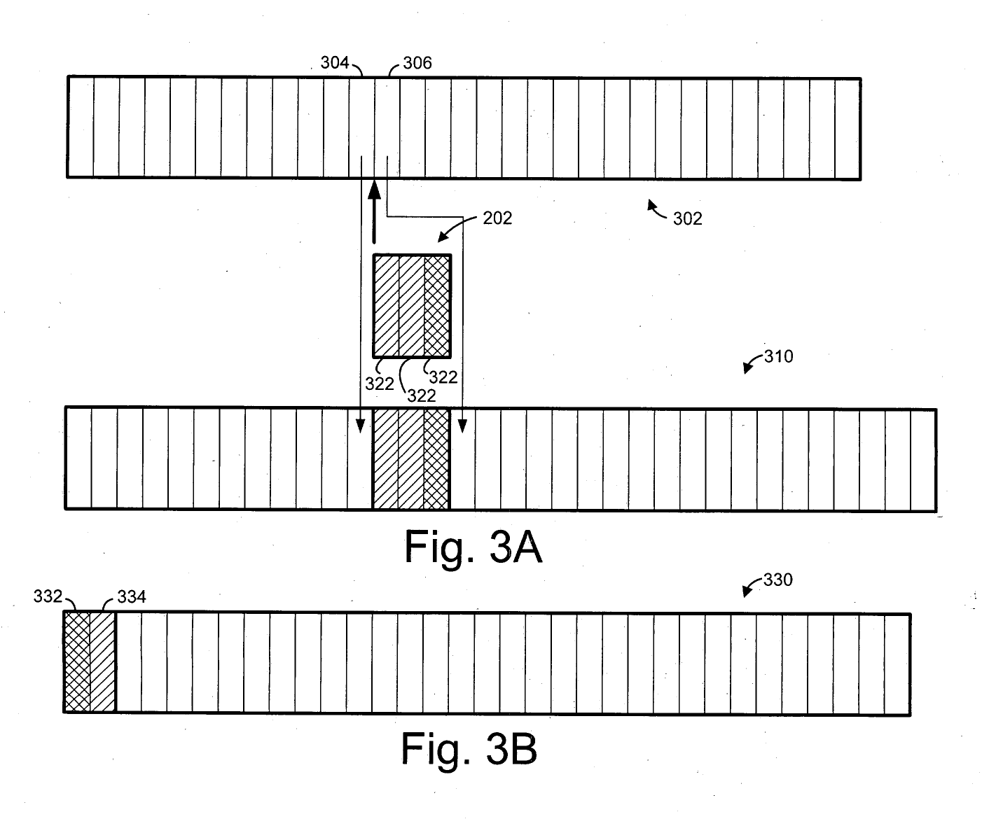

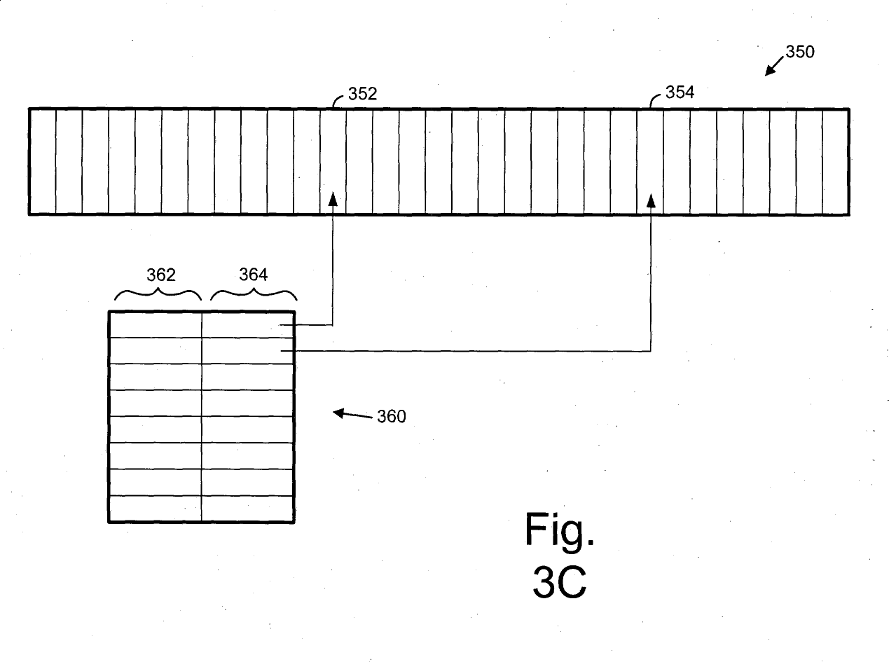

FIG. 3A shows a format where cue data is embedded with audio waveform data.

In FIG. 3A, portion of audio presentation file 302 is a series of waveform samples. For example, each sample can be a 16-bit word of digital data. It is desired to place a cue at a point in time corresponding to sample 306. In this case, the cue data needs to be embedded between samples 304 and 306 of the audio presentation file as shown by the bold arrow.

Cue data 320 for a single cue includes three words of data. Cue identifier 322 is a word of data that has a value corresponding to the type of cue to be inserted. For example, a GUITAR_RIFF_START cue has a value that indicates the type of cue. In general, many possible types of cue representations are possible. Any suitable methods for representing, embedding or associating cues with audio presentation information is within the scope of the present invention. A preferred embodiment uses a table to associate cue identifier values with cue characteristics such as a text description of the cue, the cue type, etc. In addition to cue identifier 322 are two words of data used as an “escape sequence” to indicate to a playback, or visualization engine that the cue identifier follows. Such an escape sequence can be any sequence of two words that, preferably, would not occur in audio presentation data.

The embedded cue is shown in object 310. The size of the object is increased by three words in order to place the cue data (i.e., two words of escape sequence and one word of cue identifier) in the desired location between words 304 and 306. The location of the cue data determines the cue occurrence within the audio data during playback.

FIG. 3B shows another approach to include cue data with audio presentation data. In FIG. 3B, audio presentation file 330 includes cue data at the beginning. Cue data includes cue identifier 332 and cue position index 334. Cue identifier 332 can be similar to that used in FIG. 3A. Cue position index 334 includes one or more words of data indicating the sample at which the cue is triggered. This can be a count of sample position starting from a given first sample. So, for example, if the cue is to correspond with sample number 54,328 of the audio presentation then cue position index 334 would have the value 54,328.

FIG. 3C shows an approach whereby the cue data is a separate file or object from the audio presentation data. In FIG. 3C, audio presentation file 350 includes a series of samples, as before. However, cue data now resides in object 360 which is a separate list or array of information that includes, for each cue entry, a cue identifier at 362 associated with a cue position index at 364. Each cue position index “points” to a sample in audio presentation file 350 as shown for the first two entries in object 360. These two entries can correspond, respectively, to the beginning and end of an interval such as, e.g., GUITAR_RIFF_START and GUITAR_RIFF_END.

A visualization engine can execute in a device local to a user's output devices, such as in playback device 120 of FIG. 1. The visualization engine is a process that works in concert with an audio playback process to use cues in time with the audio playback to create a visualization during audio playback. Other embodiments can locate the visualization engine in a different hardware device (e.g., in a display system, DVD player, set-top box, etc.) The visualization engine can be located remotely from the output devices as where a visualization engine is running on a remote server and display information is sent over a network, such as the Internet, to a display device. A preferred embodiment of the invention allows cue files to be obtained separately from the audio presentation data. For example, when a user inserts an audio CD or DVD into a playback device, the playback device sends a message to a server on the Internet to identify one or more songs on the media. If a cue file exists for the identified song then the cue file can be downloaded to the playback device and the visualization engine process can use the downloaded cue file to generate an enhanced visualization. The alternative cue data formats described above, can also be used to obtain cue data, such as when the cue data is embedded with, or attached to, the audio presentation data.

Cues can be synchronized to audio playback in a number of ways. As described, the embedded cue format has inherent synchronization since the cues are inserted in the audio data at the point to which the cue corresponds. With embedded data, the cue information and any associated information is removed before the audio samples are provided to an audio playback process. Similarly, with attached cue data the cue data is preferably removed from the audio data before the audio data is processed.

When cue data is in a separate file from the audio presentation it may be necessary to provide additional synchronizing information. One way to synchronize the cues with audio data is to use sample indexing as described, above. In this approach, each cue is associated with a sample number, or index, in the audio presentation. At about the time the indexed sample is played, the associated cue is executed. Generally, cue synchronizing does not have to be accurate to within less than tens of milliseconds so precise timing is not critical.

When available a standard time base can be used to synchronize cues. For example, the Society of Motion Pictures and Television Engineers (SMPTE), MIDI timecode, National Television Standards Corporation (NTSC), or other types of synchronizing signals may be present on media, or provided as a signal, during audio or video playback. DVD players, CD players, computers, or other playback devices are all able to provide some type of time signal, such as an internal system clock, running time from the start of playback, etc. Where such signals are available they can be used to synchronize cue triggering to playback. In a time-base approach, each cue is associated with a point in time (e.g., starting at 0 for the beginning of a song) at which the cue is to be executed. The time-base approach only needs to be somewhat accurate, e.g., within two tenths of a second, for most visualizations to be effective. It should be apparent that time synchronizing of cue triggers can be achieved by any of numerous suitable approaches.

Although the invention has been described with reference to specific embodiments thereof, these embodiments are merely illustrative, and not restrictive, of the invention. For example, although the system has primarily been described with respect to DVD playback, various aspects of the invention can be used with any type of audio playback where there is the capability to provide a visualization. Devices such as video players, computers, set-top boxes, etc. can be used. Any suitable format for the audio information delivery can be used such as magnetic tape, laserdisc, Compact Disk (CD), broadcast transmissions, hard disk, memory stick, digital networks (e.g., Internet, local-area-networks), etc. can be used. The audio information and associated cues can be stored, streamed or other wise transferred, controlled and manipulated by any suitable means.

Although the invention has been discussed primarily with respect to musical audio presentations, any type of audio presentation can benefit from the features of the invention. Any suitable format for the audio presentation file or cue data can be used.

Any suitable programming language can be used to implement the routines of the present invention including C, C++, Java, assembly language, etc. Different programming techniques can be employed such as procedural or object oriented. The routines can execute on a single processing device or multiple processors. The functions of the invention can be implemented in routines that operate in any operating system environment, as standalone processes, in firmware, dedicated circuitry or as a combination of these or any other types of processing.

Steps can be performed in hardware or software, as desired. Note that steps can be added to, taken from or modified from the steps in the flowcharts presented in this specification without deviating from the scope of the invention. In general, descriptions of functional steps, such as in tables or flowcharts, are only used to indicate one possible sequence of basic operations to achieve a functional aspect of the present invention.

In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

A “computer” for purposes of embodiments of the present invention may be any processor-containing device, such as a mainframe computer, a personal computer, a laptop, a notebook, a microcomputer, a server, or any of the like. A “computer program” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory.

A “processor” includes a system or mechanism that interprets and executes instructions (e.g., operating system code) and manages system resources. More particularly, a “processor” may accept a program as input, prepares it for execution, and executes the process so defined with data to produce results. A processor may include an interpreter, a compiler and run-time system, or other mechanism, together with an associated host computing machine and operating system, or other mechanism for achieving the same effect. A “processor” may also include a central processing unit (CPU) which is a unit of a computing system which fetches, decodes and executes programmed instruction and maintains the status of results as the program is executed. A CPU is the unit of a computing system that includes the circuits controlling the interpretation of instruction and their execution.

A “server” may be any suitable server (e.g., database server, disk server, file server, network server, terminal server, etc.), including a device or computer system that is dedicated to providing specific facilities to other devices attached to a network. A “server” may also be any processor-containing device or apparatus, such as a device or apparatus containing CPUs. Although the invention is described with respect to a client-server network organization, any network topology or interconnection scheme can be used. For example, peer-to-peer communications can be used.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general purpose digital computer, by using application specific integrated circuits, programmable logic devices, or field programmable gate arrays, or by using a network of interconnected components and circuits. Any communication channel or connection can be used such as wired, wireless, optical, etc.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A method for playing back an audio presentation with an accompanying visual presentation, the method comprising
detecting a cue indicating a characteristic of music of the audio presentation; and
using the cue to modify a visual presentation in synchronization with the audio presentation.

2. The method of claim 1, wherein the cue is included embedded with the audio presentation.

3. The method of claim 1, wherein the cue is included in a file separate from the audio presentation.

4. The method of claim 1, wherein the step of using the cue includes substeps of
determining a cue type; and
modifying the visual presentation in accordance with the determined cue type.

5. The method of claim 4, wherein the cue type includes an indication of volume level.

6. The method of claim 4, wherein the cue type includes an indication of frequency band strength.

7. The method of claim 4, wherein the cue type includes an indication of a beat in a song.

8. The method of claim 4, wherein the cue type includes an indication of sub-beats.

9. The method of claim 4, wherein the cue type includes an indication of a vocal performance.

10. The method of claim 9, wherein the cue type includes an indication of the start of a vocal performance.

11. The method of claim 9, wherein the cue type includes an indication of the presence of a word of vocal performance.

12. The method of claim 9, wherein the cue type includes an indication of a basic speech sound.

13. The method of claim 12, wherein the cue type includes an indication of a phoneme.

14. The method of claim 4, wherein the cue type includes an indication of a lighting effect.

15. The method of claim 4, wherein the cue type includes an indication of MIDI information.

16. The method of claim 4, wherein the cue type includes an indication of a non-physical effect.

17. The method of claim 16, wherein the cue type includes an indication of a human mood.

18. A method for authoring a visualization, the method using a display screen coupled to a user input device and to a processor, the method comprising the following steps executed by the processor
displaying a representation of an audio waveform on the display screen;
accepting signals from the user input device to create a cue at a selected point in the representation of the audio waveform;
displaying a visual indicator corresponding to the cue adjacent to the representation of the audio waveform near the selected point; and
storing an indication of the cue at the selected point.

19. The method of claim 18, wherein the step of storing includes
storing the indication of the cue in a file with data describing the audio waveform.

20. The method of claim 18, wherein the step of storing includes
storing the indication of the cue in a file separate from data describing the audio waveform.
